(19) United States
(12) Patent Application Publication
(10) Pub. No.: US 2010/0322704 A1
(43) Pub. Date: Dec. 23, 2010

(54) Joint and Anchor Pin Assembly

(76) Inventor: Qing Xin Chen, Fujian Province (CN)

Correspondence Address: CHEN QING XIN, NO 11. BUILDING 5, HUAQIAO UPTOWN, BEIMEN STREET,, LICHENG DISTRICT, QUANZHOU CITY, FUJIAN PROVINCE, 362000, CN

(21) Appl. No.: 12/446,577

(22) PCT Filed: Apr. 9, 2008
(86) PCT No.: PCT/CN07/01137

§ 371 Date: Apr. 21, 2009

(30) Foreign Application Priority Data
Feb. 1, 2007 (CN) 200720006258.8

(51) Int. Cl. B60G 7/00; F16F 1/38

(52) U.S. Cl. 403/225

(57) ABSTRACT

The present invention discloses a joint and anchor pin assembly, comprising an inner shell, an outer shell, an anchor pin and an elastomer sandwiched between the inner shell and the outer shell, in which assembly, an anchor pin rigid fixed baffle plate is additionally provided at each of both ends of the anchor pin, the inner diameter sidewall of the outer shell is protrudingly provided with a rigid annular stopping plate which extends towards the outer diameter sidewall of the inner shell and is radially movable, between the anchor pin rigid fixed baffle plate and the elastomer there is movably provided a rigid movable baffle plate that is radially movable, the rigid movable baffle plate is in the axial direction in a overlapping state with the anchor pin rigid fixed baffle plate and the elastomer, and in the radial direction in a overlapping state with the outer shell. Compared with the those in prior art, the structure of the present invention could not only prevent the elastomer from being excessively compressed and falling off, but also achieve up-and-down damping via one and the same independent elastomer, as well as assuring the left-and-right damping, and the relative closure of the structure is further achieved. The structure of the present invention has a higher structural strength, a better stability and a longer service life.

### BACKGROUND OF THE INVENTION

The present invention relates to a damping and balancing device for vehicle carriers, i.e., the rubber joint assembly of the reaction rod of the vehicle rear suspension, in particular, the rubber joint and anchor pin assembly therein.

At present, the structure of the joint and anchor pin assembly in prior art comprises an inner shell, an outer shell and the rubber sandwiched between the inner shell and the outer shell; the inner cavity wall of the inner shell is a cylindrical hole adapted for the anchor pin, and the anchor pin is tightly inserted through the inner shell. The prior art assembly adopts rubber as the elastomer, which is made through heat curing after the rubber is injected between the outer shell and the inner shell, and its function of damping and balancing is accomplished by means of the expansion and contraction characteristic of rubber. The rubber, upon playing its role in stretching resistance, compression resistance, damping and balancing, etc., although has a relatively good performance in stability and fixation, results in a poor structural strength of the components due to the physical and chemical properties of the rubber itself, as well as the deficiencies existing in rubber treatment processes. Therefore, in case no position limitation protection is provided, the inner and outer shells are easily caused to separate from the rubber once subjected to an external force that is relatively great. Moreover, since the rubber has a low stretching resistance and a low compression resistance, in case no position limitation protection is provided, it is prone to being broken and crushed, thus it has a relatively short service life.

To prevent the rubber from falling off, in the Chinese Patent of Utility Model “Improved Joint and Anchor Pin Assembly” with the Patent Number 200420072646.2, which is filed on Jun. 28, 2004 by the present Applicant, a joint and anchor pin assembly is disclosed, which is composed of an anchor pin, a joint outer shell, an elastomer, a dust-proof baffle sheet, an elastomer baffle plate. The elastomer is sandwiched between the anchor pin and the joint outer shell, and, the expansion and contraction direction of the elastomer is perpendicular to the axial direction of the anchor pin, which elastomer is caused to have a certain amount of compression. The elastomer baffle plate is disposed at each of both sides of the two ends of the anchor pin flange, which only serves to prevent the elastomer from falling off, and is incapable of limiting the compression amount of the elastomer, so provides no position limitation protection effect for the elastomer, which will be easily damaged and the service life thereof is relatively short.

For the purpose of providing an improved structure for the joint and anchor pin assembly, which may effectively prevent the elastomer from falling off and being excessively compressed, in the Chinese Patent Application “Improved Structure for a Joint and Anchor Pin Assembly” with the Application Number 200610039795.2, which is filed on Apr. 11, 2006 by the present Applicant, a joint and anchor pin assembly with an improved structure is disclosed, which structure is composed of an inner shell, an outer shell, an anchor pin and an elastomer sandwiched between the inner shell and the outer shell, in which the inner shell is disposed outside the anchor pin, characterized in that, the above said anchor pin, at appropriate positions on both ends thereof protruding out of the above said inner shell, are respectively fixedly provided with rigid inner stopping baffle plates, the above said outer shell, on both end surfaces thereof, are respectively fixed to rigid outer stopping baffle plates; the above said inner stopping baffle plate and the above said outer stopping baffle plate are in a overlapping state along the direction of the axis of the above said anchor pin, and between the above said outer stopping baffle plate and the above said anchor pin or the above said inner shell, a radial distance appropriate for the radial compression of the above said elastomer is maintained. The invention of the patent application in question, although capable of preventing the elastomer from falling off and being excessively compressed, fails to achieve the effect of causing the elastomer sandwiched between the inner shell and the outer shell to completely close for the purpose of damping and balancing.

Also mentioned herein is the Chinese Patent Application “Inverted Pendulum Type Pneumatic Vibration Isolator” with the Application Number 03141958.5, the object of which is to provide a vibration isolating device with a high vibration isolating performance, which is composed of an air bag in the form of the inverted pendulum type structure, having a very low natural frequency which is manually adjustable. This invention is conceived and embodied as follows: the body of the inverted pendulum type composing the inverted pendulum type pneumatic vibration isolator is connected integrally with a suspension ring through an elastic membrane, and the whole body thus connected together is rested on the ball bearing inside the base seat, and pendulating with said ball bearing as the fulcrum. A post for supporting the working bedplate is seated within the suspension, and the hollow cavity inside the inverted pendulum type body is divided into an air bag elastic cavity and an air bag damping cavity via a partition, said two cavities communicating with each other through a damping hole. At the upper portion of the base seat, a plurality of horizontally adjustable springs are evenly distributed on the same horizontal plane, via which springs the inverted pendulum type body is connected with the base seat, so that the intended purpose is effectively achieved. The structure of this invention suffers from the shortcoming that, to achieve the function of vibration isolation in the vertical and horizontal directions, a plurality of different elastomers are indispensable.

### BRIEF SUMMARY OF THE INVENTION

The object of the present invention is to provide a joint and anchor pin assembly, which is capable of effectively not only preventing the elastomer from falling off, but also preventing the elastomer from being compressed excessively, furthermore, which assures that even in case of one and the same independent elastomer is utilized to provide the effect of more effective damping and balancing all-around, the relative degree of closure of the construction is greatly increased and the stability is enhanced.

The technical solution of the present invention is as follows: a joint and anchor pin assembly, comprising an inner shell, an outer shell, an anchor pin and an elastomer sandwiched between the inner shell and the outer shell, the inner shell being disposed outside the anchor pin; the above said anchor pin at appropriate positions on both ends protruding out of the above said inner shell are respectively provided with rigid stopping devices, i.e., anchor pin rigid stopping devices; the inner diameter sidewall of the above said outer shell is protrudingly provided with a rigid annular stopping baffle plate extending towards the outer diameter sidewall of the above said inner shell, and between the inner diameter of this stopping baffle plate and the outer diameter sidewall of the above said inner shell is maintained a gap for radial expansion and contraction of the above said elastomer.

The above said anchor pin rigid stopping device is an anchor pin rigid fixed baffle plate, the outer diameter of which is smaller than the inner diameter of the above said outer shell, and the dimension of the gap between its outer diameter and the inner diameter of the above said outer shell is determined according to the limit of the compression amount of the above said elastomer.

The above said anchor pin rigid stopping device is an anchor pin rigid fixed baffle plate, and is further provided with a rigid movable baffle plate that is respectively movable in correspondence with the above said anchor pin rigid fixed baffle plate, the rigid movable baffle plate is in the axial direction respectively located between the above said anchor pin rigid fixed baffle plate and the above said elastomer, the rigid movable baffle plate is in the radial direction located between the above said anchor pin and the above said outer shell, and a gap is maintained between the above said anchor pin and the above said outer shell for radial movement of the rigid movable baffle plate, and the above said rigid movable baffle plate is in the axial direction in a overlapping state with the above said anchor pin rigid fixed baffle plate and the above said elastomer, and in the radial direction in a overlapping state with the above said outer shell.

The outer diameter sidewall of the above said inner shell is provided with an annular groove corresponding to the above said rigid annular stopping plate, the above said annular groove is provided with gaps in the axial direction and in the radial direction for movement of the above said rigid annular stopping plate.

The above said rigid annular stopping plate is a flange integrally formed with the inner diameter sidewall of the above said outer shell.

The above said rigid annular stopping plate is fixed to the axially central portion of the inner diameter sidewall of the above said outer shell.

By adopting the above described solution, in addition to the effect of damping and balancing in the radial direction that is commonly known, the anchor pin rigid fixed baffle plate or the rigid movable baffle plate of the present invention and the rigid annular stopping plate on the inner diameter sidewall of the outer shell are capable of sandwiching the elastomer therebetween in the direction of the axis of the anchor pin. Upon the vehicle running on a rugged road, relative movement of the elastomer may occur on the two different bodies so as to provide the effect of damping and balancing in the axial direction. Upon additionally providing the rigid movable baffle plate, the relative degree of closure of the whole joint and anchor pin assembly is greatly improved, so the range of choice regarding the types of elastomer is wider, thus, through utilization of various elastomers, the cost could be greatly reduced. Compared with those in prior art, the structure of the present invention could not only prevent the elastomer from being excessively compressed and falling off, but also achieve up-and-down damping via one and the same independent elastomer, as well as assuring the left-and-right damping, and the relative closure of the structure is further achieved. A higher structural strength, a better stability and a longer service life of the improved structure constitute the most distinctive points as compared with those of the prior art structures from a technical point of view.

### BRIEF DESCRIPTION OF THE DRAWINGS

FIG. 1 is the structural illustration view of the first embodiment according to the present invention;

FIG. 2 is the structural illustration view of the second embodiment according to the present invention;

FIG. 3 is the structural illustration view of the third embodiment according to the present invention;

FIG. 4 is the structural illustration view of the fourth embodiment according to the present invention;

FIG. 5 is the structural illustration view of the fifth embodiment according to the present invention;

FIG. 6 is the structural illustration view of the sixth embodiment according to the present invention;

FIG. 7 is the structural illustration view of the seventh embodiment according to the present invention.

### DETAILED DESCRIPTION OF THE INVENTION

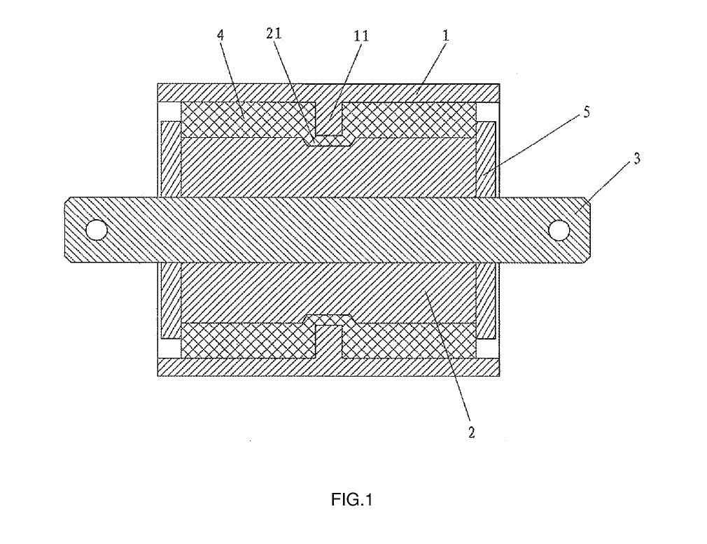

The first embodiment of the present invention is as shown in FIG. 1, which comprises an outer shell 1, an inner shell 2, an anchor pin 3 and an elastomer 4, the outer shell 1 is longer than the inner shell 2, the elastomer 4 is filled between the outer shell 1 and the inner shell 2, the anchor pin 3 is insertedly disposed inside the inner shell 2, the anchor pin 3 is provided, at the portions corresponding to both end surfaces of the inner shell 2, with anchor pin rigid fixed baffle plates 5, the size of the outer diameter of the anchor pin rigid fixed baffle plate 5 may be determined as desired in practice, the outer diameter of the anchor pin rigid fixed baffle plate 5 of the present embodiment is smaller than the inner diameter of the outer shell 1, the size of which may be determined by the limit of the radial compression of the elastomer 4. The axially central portion of the inner diameter sidewall of the outer shell 1 is protrudingly provided with a rigid annular stopping plate 11 extending towards the outer diameter sidewall of the inner shell 2, the outer diameter sidewall of the inner shell 2 is provided at the corresponding portion with an annular groove 21, the inner diameter of the rigid annular stopping plate 11 is slightly larger than the outer diameter of the inner shell 2 to facilitate installation, the depth of the annular groove 21 may be determined by the limit of the amount of radial compression of the elastomer 4, and a gap is maintained within the annular groove 21 in both the axial and the radial directions for movement of the rigid annular stopping plate 11, and the size of this gap may be determined by the limit of the amount of axial compression of the elastomer 4.

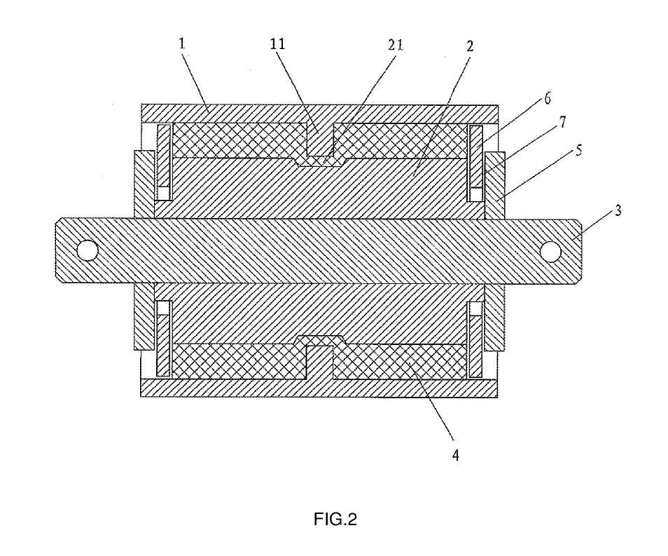

The second embodiment of the present invention is as shown in FIG. 2, which comprises an outer shell 1, an inner shell 2, an anchor pin 3 and an elastomer 4, both ends of the outer shell 1 are flush with those of the inner shell 2, the elastomer 4 is filled between the outer shell 1 and the inner shell 2, the anchor pin 3 is insertedly disposed inside the inner shell 2, the anchor pin 3 is provided, at the portions corresponding to both end surfaces of the inner shell 2, with anchor pin rigid fixed baffle plates 5, the size of the outer diameter of the anchor pin rigid fixed baffle plate 5 may be determined as desired in practice, the outer diameter of the anchor pin rigid fixed baffle plate 5 of the present embodiment is smaller than the inner diameter of the outer shell 1. The axially central portion of the inner diameter sidewall of the outer shell 1 is protrudingly provided with a rigid annular stopping plate 11 extending towards the outer diameter sidewall of the inner shell 2, the outer diameter sidewall of the inner shell 2 is provided at the corresponding portion with an annular groove 21, the inner diameter of the rigid annular stopping plate 11 is slightly larger than the outer diameter of the inner shell 2 to facilitate installation, the depth of the annular groove 21 may be determined by the limit of the amount of radial compression of the elastomer 4, and a gap is maintained within the annular grooves 21 in both the axial and the radial directions for movement of the rigid annular stopping plate 11, and the size of this gap may be determined by the limit of the amount of axial compression of the elastomer 4. Each of both ends of the inner shell 2 is respectively recessed inwardly so as to form a step, thus an annular groove 7 is formed between this step and the anchor pin rigid fixed baffle plate 5, the circular-ring shaped rigid movable baffle plate 6 is movably provided within the annular groove 7, the rigid movable baffle plate 6 in the radial direction is in a overlapping state with the outer shell 1, and a gap is maintained within the annular groove 7 in the radial direction for radial movement of the rigid movable baffle plate 6, and the size of this gap may be determined by the limit of the amount of radial compression of the elastomer 4. The rigid movable baffle plate 6 in the axial direction is in a overlapping state with the anchor pin rigid fixed baffle plate 5 and the elastomer 4, and the outer peripheral of the rigid movable baffle plate 6 should be located inside the inner diameter sidewall of the outer shell 1 so as to assure that the elastomer could provide its effect of damping and balancing by moving along the inner sidewall of the outer shell 1 in the axial direction.

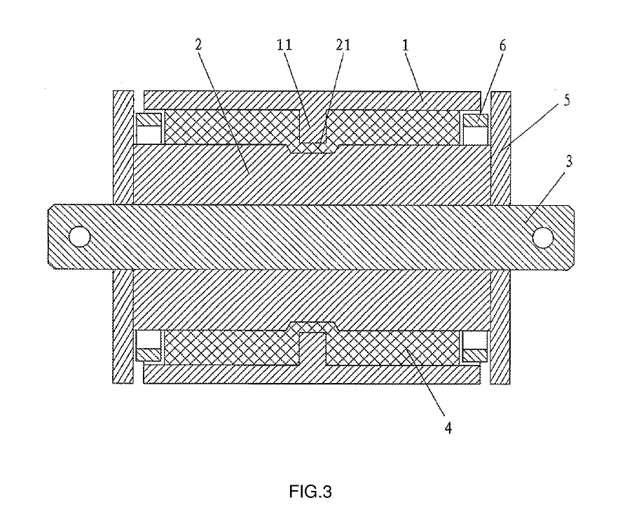

The third embodiment of the present invention is as shown in FIG. 3, which comprises an outer shell 1, an inner shell 2, an anchor pin 3 and an elastomer 4, the outer shell 1 is shorter than the inner shell 2, each of both ends of the inner shell 2 extends out of the outer shell 1, the elastomer 4 is filled between the outer shell 1 and the inner shell 2, the anchor pin 3 is insertedly disposed inside the inner shell 2, the anchor pin 3 is provided, at the portions corresponding to both end surfaces of the inner shell 2, with anchor pin rigid fixed baffle plates 5, the size of the outer diameter of the anchor pin rigid fixed baffle plate 5 may be determined as desired in practice, the outer diameter of the anchor pin rigid fixed baffle plate 5 of the present embodiment is larger than the inner diameter of the outer shell 1. The axially central portion of the inner diameter sidewall of the outer shell 1 is protrudingly provided with a rigid annular stopping plate 11 extending towards the outer diameter sidewall of the inner shell 2, the outer diameter sidewall of the inner shell 2 is provided at the corresponding portion with an annular groove 21, the inner diameter of the rigid annular stopping plate 11 is slightly larger than the outer diameter of the inner shell 2 to facilitate installation, the depth of the annular groove 21 may be determined by the limit of the amount of radial compression of the elastomer 4, and a gap is maintained within the annular groove 21 in the axial direction for movement of the rigid annular stopping plate 11, and the size of this gap may be determined by the limit of the amount of axial compression of the elastomer 4. Each of both ends of the inner shell 2 is movably provided with a circular-ring shaped rigid movable baffle plate 6, the rigid movable baffle plate 6 in the radial direction is in a overlapping state with the outer shell 1, and a gap is maintained between the outer shell 1 and the inner shell 2 for radial movement of the rigid movable baffle plate 6, and the size of this gap may be determined by the limit of the amount of compression of the elastomer 4. The rigid movable baffle plate 6 in the axial direction is in a overlapping state with the anchor pin rigid fixed baffle plate 5 and the elastomer 4, and the outer peripheral of the rigid movable baffle plate 6 should be located inside the inner diameter sidewall of the outer shell 1 so as to assure that the elastomer could provide its effect of damping and balancing in the axial direction.

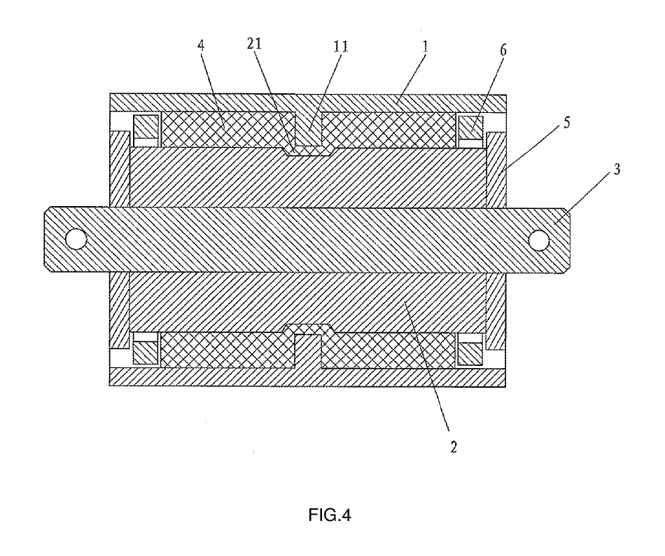

The fourth embodiment of the present invention is as shown in FIG. 4, which is different from the third embodiment in that the outer shell 1 is longer than the inner shell 2, the anchor pin rigid fixed baffle plates 5 are respectively positioned inside both ends of the outer shell 1, and the outer diameter of the anchor pin rigid fixed baffle plate 5 is smaller than the inner diameter of the outer shell 1, and the size of this outer diameter may be determined by the limit of the compression amount of the elastomer 4.

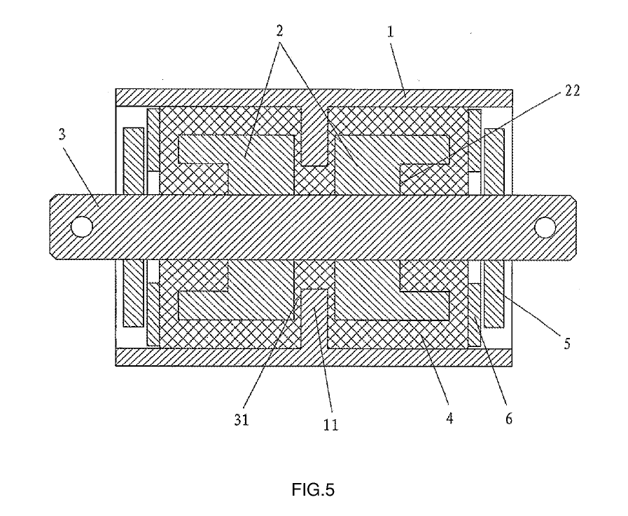

The fifth embodiment of the present invention is as shown in FIG. 5, which comprises an outer shell 1, an inner shell 2, an anchor pin 3 and an elastomer 4, the anchor pin 3 is insertedly disposed inside the inner shell 2, the outer shell 1 is longer than the inner shell 2, the inner shell 2 is of a two-section type, the outer end surfaces of both sections of the inner shell 2 are respectively provided with recessed cavities 22, the elastomer 4 is filled between the outer shell 1 and the inner shell 2 and within the recessed cavities 22, the anchor pin 3 is fixedly provided, at the appropriate portions extending out of both ends of the inner shell 2, with anchor pin rigid fixed baffle plates 5, the size of the outer diameter of the anchor pin rigid fixed baffle plate 5 may be determined as desired in practice, the outer diameter of the anchor pin rigid fixed baffle plate 5 of the present embodiment is smaller than the inner diameter of the outer shell 1. The axially central portion of the inner diameter sidewall of the outer shell 1 is protrudingly provided with a rigid annular stopping plate 11 extending towards the outer diameter sidewall of the inner shell 2, an interval is maintained between both sections of the inner shell 2, between which interval and the anchor pin 3 is formed an annular groove 31, one end of the rigid annular stopping plate 11 is protrudingly disposed within this annular groove 31, and a gap is maintained within the annular groove 31 in both the radial and the axial directions for movement of the rigid annular stopping plate 11, and the size of this gap may be determined by the limit of the compression amount of the elastomer 4. Each of both ends of the anchor pin 3 located between the anchor pin rigid fixed baffle plate 5 and the elastomer 4 is respectively movably provided with a circular-ring shaped rigid movable baffle plate 6, the rigid movable baffle plate 6 in the radial direction is in a overlapping state with the outer shell 1, and a gap is maintained between the outer shell 1 and the anchor pin 3 for radial movement of the rigid movable baffle plate 6, and the size of this gap may be determined by the limit of the amount of compression of the elastomer 4. The rigid movable baffle plate 6 in the axial direction is in a overlapping state with the anchor pin rigid fixed baffle plate 5 and the elastomer 4, and the outer peripheral of the rigid movable baffle plate 6 should be located inside the inner diameter sidewall of the outer shell 1 so as to assure that the elastomer could provide its effect of damping and balancing in the axial direction.

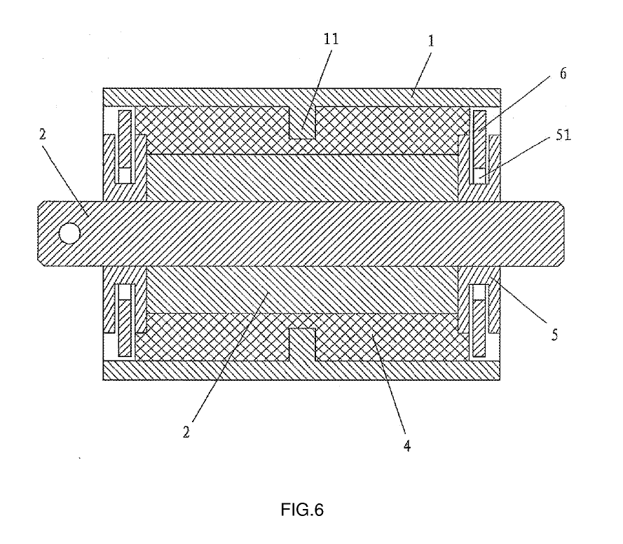

The sixth embodiment of the present invention is as shown in FIG. 6, which comprises an outer shell 1, an inner shell 2, an anchor pin 3 and an elastomer 4, the anchor pin 3 is insertedly disposed inside the inner shell 2, the elastomer 4 is filled between the outer shell 1 and the inner shell 2, the outer shell 1 is longer than the inner shell 2, the anchor pin 3 is fixedly provided, at the appropriate portions corresponding to both end surfaces the inner shell 2, with anchor pin rigid fixed baffle plates 5, the size of the outer diameter of the anchor pin rigid fixed baffle plate 5 may be determined as desired in practice, the outer diameter of the anchor pin rigid fixed baffle plate 5 of the present embodiment is smaller than the inner diameter of the outer shell 1. The axially central portion of the inner diameter sidewall of the outer shell 1 is protrudingly provided with a rigid annular stopping plate 11 extending towards the outer diameter sidewall of the inner shell 2, a gap is maintained between the inner diameter sidewall of the outer shell 1 and the outer diameter sidewall of the inner shell 2 in the radial direction for movement of the rigid annular stopping plate 11, and the size of this gap may be determined by the limit of the amount of compression of the elastomer 4. The axially central portion of the anchor pin rigid fixed baffle plate 5 is provided with an annular groove 51, in the annular groove 51 there is movably provided a circular-ring shaped rigid movable baffle plate 6, the rigid movable baffle plate 6 in the radial direction is in a overlapping state with the outer shell 1, and a gap is maintained between the outer shell 1 and the annular groove 51 for radial movement of the rigid movable baffle plate 6, and the size of this gap may be determined by the limit of the amount of compression of the elastomer 4. The rigid movable baffle plate 6 in the axial direction is in a overlapping state with the anchor pin rigid fixed baffle plate 5 and the elastomer 4, and the outer peripheral of the rigid movable baffle plate 6 should be located inside the inner diameter sidewall of the outer shell 1 so as to assure that the elastomer could provide its effect of damping and balancing in the axial direction.

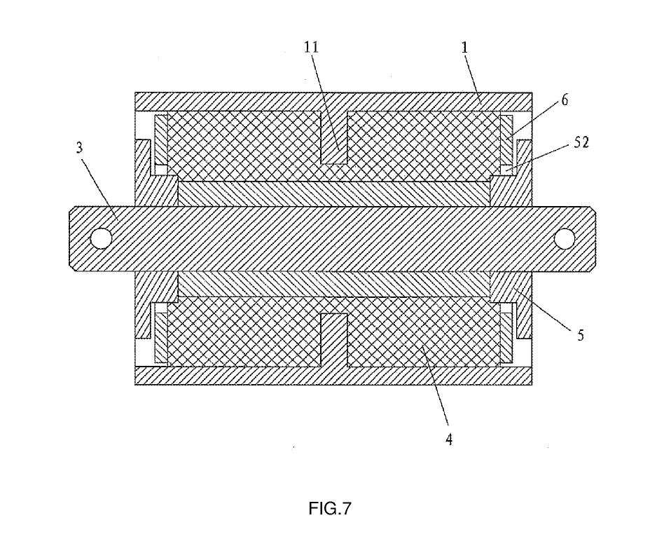

The seventh embodiment of the present invention is as shown in FIG. 7, which is different from the sixth embodiment in that the annular grooves 51 of the anchor pin rigid fixed baffle plate 5 is substituted by an annular step 52 closely adjacent to both end surfaces of the inner shell 2, the rigid movable baffle plate 6 is movably provided on this annular step 52, and a gap is maintained between the bottom of this annular step 52 and the inner diameter sidewall of the outer shell 1 for radial movement of the rigid movable baffle plate 6.

The above described embodiments of the present invention are merely some examples taken for purpose of clearly illustrating the present invention, which are not intended to limit the modes for carrying out the present invention. To those having ordinary skills in the art, different changes or modifications may be made regarding the forms of the structure upon the basis of the above description. The embodiments of the present invention are not necessary to and could not be listed here in an exhaustive manner. However, these obvious changes or modifications made within the spirit of the present invention are intended to be covered by the appended claims of the present invention.

I claim:

1. A joint and anchor pin assembly, comprising an inner shell, an outer shell, an anchor pin and an elastomer sandwiched between the inner shell and the outer shell, the inner shell being disposed outside the anchor pin; characterized in that, the above said anchor pin at appropriate positions on both ends protruding out of the above said inner shell is respectively provided with rigid stopping devices, i.e., anchor pin rigid stopping devices; the inner diameter sidewall of the above said outer shell is protrudingly provided with a rigid annular stopping baffle plate extending towards the outer diameter sidewall of the above said inner shell, and between the inner diameter of this stopping baffle plate and the outer diameter sidewall of the above said inner shell is maintained a gap for radial expansion and contraction of the above said elastomer.

2. The joint and anchor pin assembly according to claim 1, characterized in that, the above said anchor pin rigid stopping device is an anchor pin rigid fixed baffle plate, the outer diameter of which is smaller than the inner diameter of the above said outer shell, and the dimension of the gap between its outer diameter and the inner diameter of the above said outer shell is determined according to the limit of the compression amount of the above said elastomer.

3. The joint and anchor pin assembly according to claim 1, characterized in that, the above said anchor pin rigid stopping device is an anchor pin rigid fixed baffle plate, and is further provided with a rigid movable baffle plate that is respectively movable in correspondence with the above said anchor pin rigid fixed baffle plate, the rigid movable baffle plate is in the axial direction respectively located between the above said anchor pin rigid fixed baffle plate and the above said elastomer, the rigid movable baffle plate is in the radial direction located between the above said anchor pin and the above said outer shell, and a gap is maintained between the above said anchor pin and the above said outer shell for radial movement of the rigid movable baffle plate, and the above said rigid movable baffle plate is in the axial direction in a overlapping state with the above said anchor pin rigid fixed baffle plate and the above said elastomer, in the radial direction in a overlapping state with the above said outer shell.

4. The joint and anchor pin assembly according to claim 1, characterized in that, the outer diameter sidewall of the above said inner shell is provided with an annular groove corresponding to the above said rigid annular stopping plate, the above said annular groove is provided with gaps in the axial direction and in the radial the direction for movement of the above said rigid annular stopping plate.

5. The joint and anchor pin assembly according to claim 1, characterized in that, the above said rigid annular stopping plate is a flange integrally formed with the inner diameter sidewall of the above said outer shell.

6. The joint and anchor pin assembly according to claim 1, characterized in that, the above said rigid annular stopping plate is located at the axially central portion of the inner diameter sidewall of the above said outer shell.
